(19) United States
(12) Patent Application Publication
(10) Pub. No.: US 2004/0142081 A1
(43) Pub. Date: Jul. 22, 2004

(54) Method and installation for the continuous preparation of pellets for the production of snack type food products

(76) Inventors: Daniel Durand, Feugerolles (FR); Jean-Marie Bouvier, Saint Etienne (FR); Laurent Bruyas, Saint Ferreol D'Auroure (FR); Pascal Tabouillot, Riom (FR); Denis Despre, Riom (FR)

Correspondence Address: Morris Liss, Connolly Bove Lodge & Hutz, P O Box 19088, Washington, DC, 20036-3425, US

(21) Appl. No.: 10/469,597

(22) PCT Filed: Mar. 1, 2002
(86) PCT No.: PCT/FR02/00763

(30) Foreign Application Priority Data
Mar. 2, 2001 (FR) 01 02913

(51) Int. Cl. A01J 1/00

(52) U.S. Cl. 426/516

(57) ABSTRACT

The invention relates to a method for the continuous preparation of pellets intended for the production of crusty and honeycombed snack-type food products from a natural starchy raw material having a starch content that is equal to or greater than 60% and a protein content below 13%. According to the invention, the raw material is preconditioned; said raw material is fed continuously into an extrusion machine with two co-rotary and co-penetrating screws; a supply and transport step, a cooking step, a degassing step and a cooling step are performed in the extrusion machine; a continuous bead of cooked dough having a moisture content of between 20 and 30% is formed; the dough is oriented in a vertical direction and pushed through a multiple-outlet mould to form several continuous beads; the beads are cut transversely to form pellets. The pellets are subsequently dried to produce pellets having a moisture content of between 10 and 12%. The invention also relates to an installation for the continuous preparation of pellets.

The present invention relates to a process and an installation for the continuous production of pellets that are intended for the manufacture of snack-type food products with a cellular and crunchy texture from a starchy raw material having a starch content equal to or greater than 60% and a protein content of less than 13%.

The invention also relates to a food product in the form of expandable pellets that can be obtained by such a production process and are intended for the manufacture of snacks with a cellular and crunchy texture.

The pellets are semifinished products produced from a starchy raw material and having a low water content of between 10 and 20% and a high bulk density. These products have a gelatinized and glassy appearance.

These pellets are intended to be subsequently expanded, for example in the presence of hot air at a temperature of around 250° C. or in an oil bath at a temperature of around 180° C., and once expanded they are assimilated into snacks. The pellets have a lifetime of more than one year and, for the user, they permit easier production control.

The production of pellets intended for the manufacture of snack-type food products comprises a succession of several steps, these being:

preconditioning the raw material by adding water and/or steam in order to obtain a mixture possessing a moisture content of between 15 and 40%;

cooking the mixture at a temperature of between 90 and 150° C., allowing the starches to be converted and gelatinized in order to obtain a dough possessing a moisture content of between 15 and 40%;

densifying and shaping the dough;

individually cutting the products;

drying the products by reducing their moisture to a content of around 11%;

resting the product in order to obtain a uniform distribution of water within the pellet; and

expanding the pellets, for example in the presence of hot air or in an oil bath.

Hitherto, in the conventional processes, the cooking step is carried out in a first extruder having a single screw or two co-rotating screws and provided with a cylindrical die in order to form several continuous strands of dough that are cut so as to obtain a product in the form of beads several millimeters in diameter.

The beads are then sent into a second extruder having a single screw, which makes it possible to compress the particles and to obtain a homogeneous dough, which leaves this second extruder in the form of a continuous extrudate.

This extrudate is transferred directly to a mold in order to form several strands that are cut into pellets of the desired shape.

However, this process is a two-step process that uses a first extruder for cooking and a second extruder for forming, consequently involving means for transferring the product between the two extruders and means for maintaining its temperature, thereby increasing the pellet manufacturing time, which is around 4 to 8 minutes.

In addition, the startup time of the installation is relatively long, of the order of one hour, given the number of extruders that make up this installation.

Finally, the raw material used in the known processes is a starchy raw material having at least one modified and/or pregelatinized part, which is an expensive raw material.

The object of the invention is to avoid these drawbacks by proposing a process and an installation for the continuous production of pellets that are intended for the manufacture of snack-type food products, without a charging break in the manufacturing line and allowing a product of excellent quality to be obtained, while reducing the manufacturing time and the consumption of energy.

The subject of the invention is therefore a process for the continuous production of pellets that are intended for the manufacture of snack-type food products with a cellular and crunchy texture from a natural starchy raw material having a starch content equal to or greater than 60% and a protein content of less than 13%, characterized in that:

the material is preconditioned by adding water and/or steam in order to bring the moisture content of said raw material to between 15 and 40%;

the material is continuously introduced into a twin-screw extruder having intermeshing co-rotating screws rotated at a speed of greater than 200 rpm about parallel axes inside a barrel, the residence time of the material in the extruder being between 30 seconds and 1 min 30 s;

the following steps are carried out in succession in the barrel of the extruder:

a step of feeding and transporting the raw material,

a step of cooking this raw material at a temperature of between 90 and 150° C. and with a residence time of said material equal to or greater than 25 seconds, said cooking step comprising between two and five mixing steps in order to form a cooked dough having a moisture content of between 24 and 35% and

a step of venting the dough and a step of pumping and cooling it to a temperature of between 80 and 100° C.;

a continuous dough extrudate having a moisture content of between 20 and 30% is formed at the exit of the extruder;

the dough extrudate is oriented into a vertical direction so as to flow downward through an orienting chamber and at the same time the flow of the dough is regulated;

the dough is introduced into a spreading chamber and, on leaving this chamber, the dough is pushed through a multi-outlet mold in order to form a multitude of continuous strands having the desired shape;

said strands are cut transversely in order to form the pellets with a moisture content of between 20 and 30%; and

the pellets are progressively dried at a temperature of between 50 and 110° C. and a relative humidity of between 40 and 80% for more than three hours in order to obtain pellets having a moisture content of between 10 and 12%.

The subject of the invention is also an installation for the continuous production of pellets that are intended for the manufacture of snack-type food products with a cellular and crunchy texture from a natural starchy raw material having a starch content equal to or greater than 60% and a protein content of less than 13%, characterized in that it comprises:

a preconditioner for mixing water and/or steam with the raw material in order to bring the moisture content of said raw material to between 15 and 40%;

an extruder formed from two intermeshing co-rotating screws rotated at a speed of greater than 200 rpm about parallel axes inside an elongate barrel provided with intersecting bores, the length of the screws being between 32 and 48 times the diameter of said screws and said screws defining, from the upstream end to the downstream end:

a zone for the continuous feeding into the barrel of the preconditioned raw material and for transporting this raw material,

a zone for cooking this raw material at a temperature of between 90 and 150° C. and with a residence time of said raw material equal to or greater than 25 seconds, the length of the screws in the cooking zone being between 18 and 30 times the diameter of one of said screws and this cooking zone comprising between two and five mixing screw segments in order to obtain a cooked dough having a moisture content of between 24 and 35%,

a zone for venting the cooked dough and a zone for pumping and cooling it to a temperature of between 80 and 100° C. and

a zone for discharging the dough from the extruder in order to form a continuous dough extrudate having a moisture content of between 20 and 30%;

a chamber for orienting the cooked dough extrudate into a vertical direction so as to flow downward and for regulating the flow of the dough;

a chamber for spreading the cooked dough, provided at its exit with a multi-outlet mold in order to form a number of continuous strands having the desired shape;

means for cutting said strands transversely in order to form the pellets; and

means for progressively drying the pellets at a temperature of between 50 and 110° C. and a relative humidity of between 40 and 80% for more than three hours in order to obtain pellets having a moisture content of between 10 and 12%.

The subject of the invention is also a food product in the form of expandable pellets that are intended for the manufacture of snacks, characterized in that it is obtained by the abovementioned production process.

According to other features of the invention, the product is produced from a natural starchy raw material having a starch content equal to or greater than 60% and a protein content of less than 13%, the starchy raw material being based on cereals and/or tubers.

Other features and advantages of the invention will appear in the course of the following description, given with reference to the appended drawings in which:

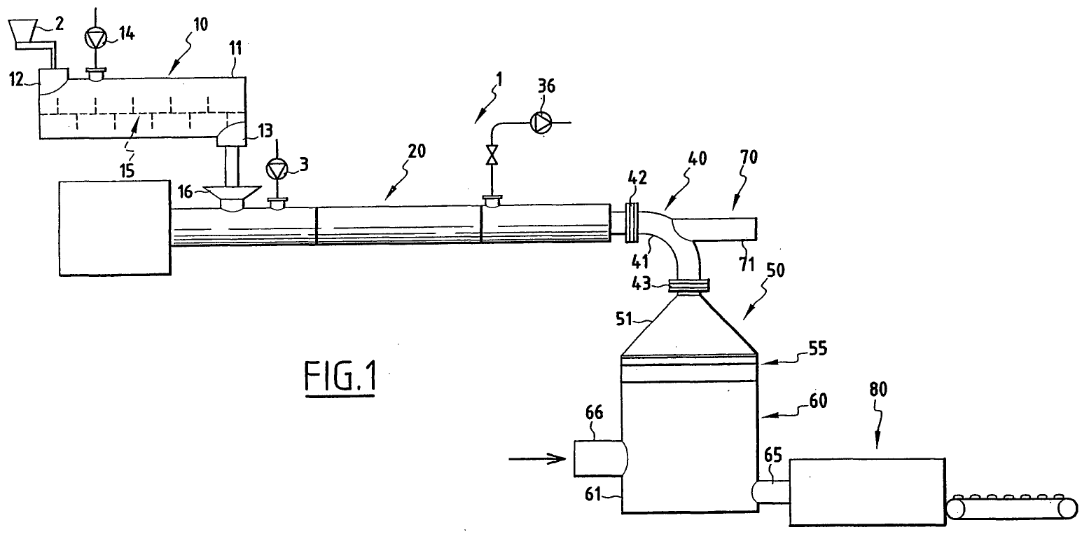

FIG. 1 is a schematic side view of an installation for the continuous production of food products in the form of pellets, according to the invention;

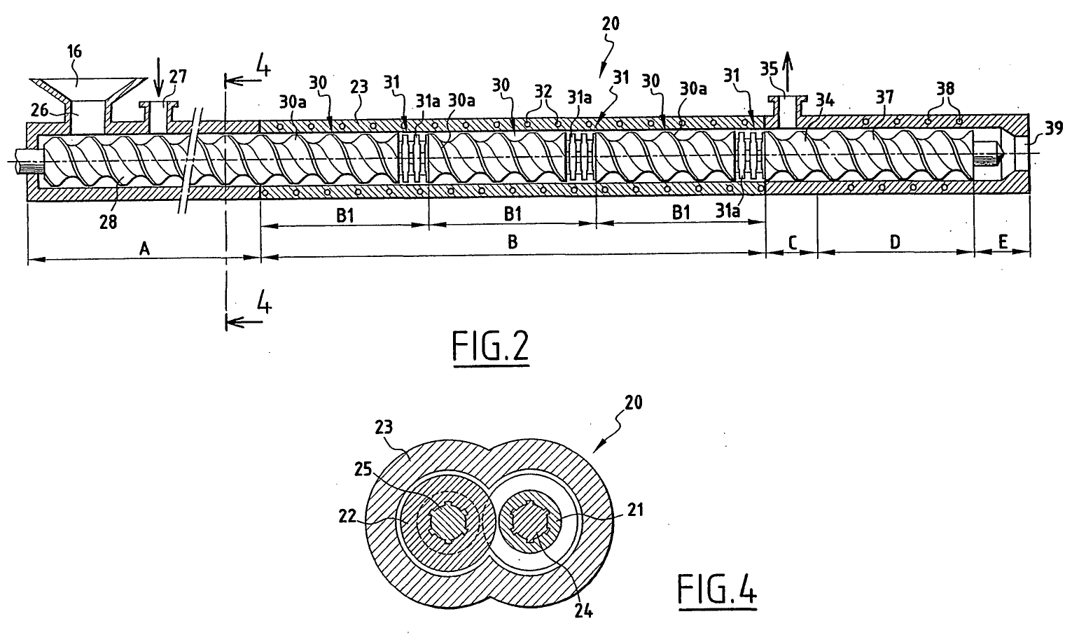

FIG. 2 is a sectional view in a vertical plane passing through the axis of a screw of an extruder of the installation according to the invention;

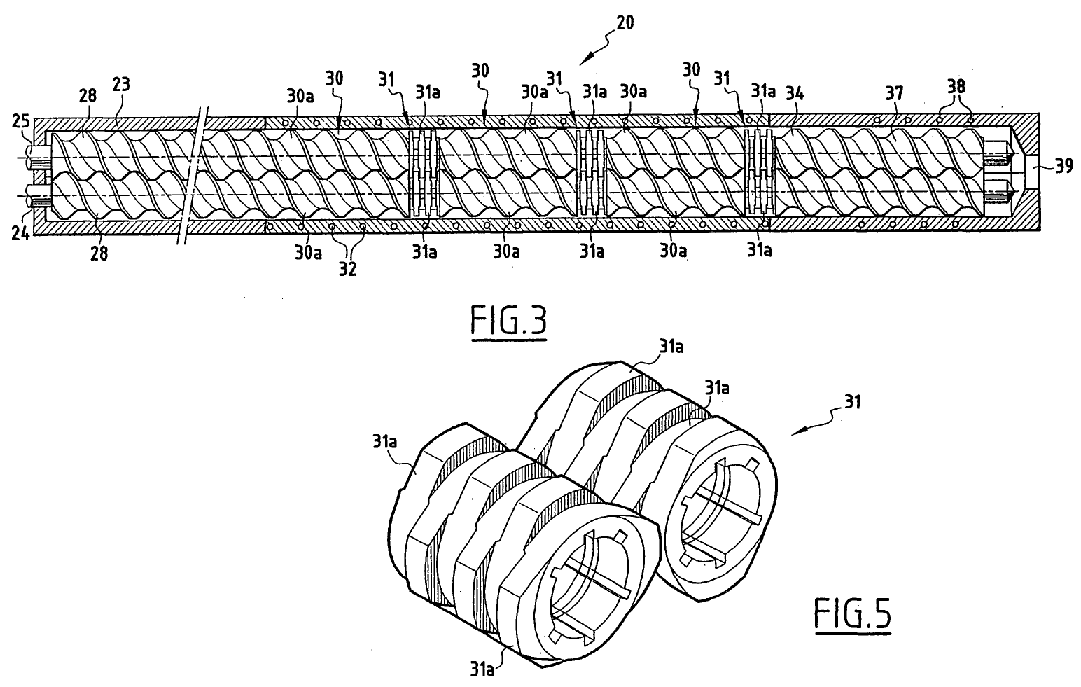

FIG. 3 is a longitudinal sectional view of the extruder;

FIG. 4 is a cross-sectional view on the line 4-4 of FIG. 3;

FIG. 5 is a schematic perspective view of one portion of the screws in the cooking and mixing zone of the extruder; and

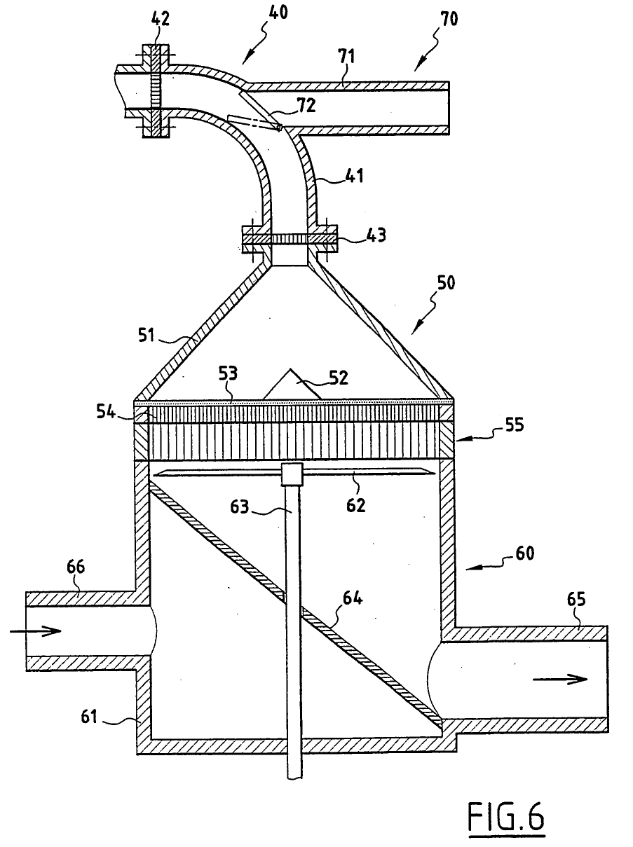

FIG. 6 is a schematic sectional view of the dough orienting and distributing chambers and of the cutting means of the installation according to the invention.

FIG. 1 shows schematically an installation for the continuous production of pellets that are intended for the manufacture of snack-type food products with a cellular and crunchy texture from a natural starchy raw material whose moisture content is between 9 and 14%. This raw material preferably has a starch content equal to or greater than 60% and a protein content of less than 13%.

The starchy raw material that can be used within the context of the invention may be a material based on cereals, such as, for example, a wheat, corn, rice, barley or oat flour, or a mixture of these flours, or else this material may be a flour based on tubers, such as, for example, manioc, potato or a mixture of these products. This starchy raw material may contain up to 100% native starch and its particle size is between 50 and 800 microns.

The term “native starch” is understood to mean a starch that has undergone no physical and/or chemical pretreatment and can be used without any modification.

Generally speaking, the installation denoted in its entirety by the reference 1 comprises:

a preconditioner 10 fed with raw material via a metering device 2;

an extruder, denoted by the general reference 20, which, as will be seen later, is formed with two intermeshing co-rotating screws;

a chamber 40 for orienting the dough extrudate output by the extruder 20;

a chamber 50 for spreading the dough in a multi-outlet mold 55;

transverse cutting means 60 for forming the pellets; and

pellet drying means 80 for obtaining pellets having a moisture content of between 10 and 12%.

The installation may also include means (not shown) for expanding these pellets in the presence of hot air at a temperature of about 250° C. or in an oil bath at a temperature of around 180° C. in order to obtain snacks having a moisture content of less than 3%.

The preconditioner is formed by an enclosure 11 provided, at its upstream end, with a port 12 for introducing the raw material into the enclosure 11 by means of the metering device 2 and, at its downstream end, with a port 13 for outputting the raw material, the moisture content of which has been raised to a value of between 15 and 40%. To do this, the enclosure 11 of the preconditioner 10 is connected to water and/or steam supply means, consisting for example of a pump 14, and the raw material is mixed in the enclosure 11 with water and/or with steam and transported to the output orifice 13 by means of two shafts provided with adjustable blades and denoted by the reference 15. Salt or sugar may also be introduced with the raw material into the enclosure 11 of the preconditioner.

The starchy raw material thus moistened and/or more or less gelatinized is introduced into the extruder 20 by means of a feed hopper 16 and this extruder is of the intermeshing co-rotating twin-screw type, as shown in FIGS. 2 and 3.

The extruder 20 has two screws 21 and 22 rotated about their axes by a motor and a reduction gear (these not being shown) inside an elongate enclosure forming a barrel 23 that envelopes them.

The screws 21 and 22 are provided in particular with helical flights or with segments for the treatment of the raw material introduced into the barrel 23, as will be seen later, which screws mesh with each other, and the internal wall of said barrel 23 forms two intersecting cylindrical lobes of inside diameter slightly greater than the outside diameter of the flights and of the treatment segments.

The two screws 21 and 22 are driven at the same rotation speed and in the same direction in such a way that these two screws are identical, the flights and the treatment segments being simply offset with respect to one another.

As in particular FIG. 4 shows, the screws 21 and 22 advantageously consist of splined shafts, 24 and 25 respectively, on which the screw portions are stacked.

The internal bore of these screw portions is provided with grooves corresponding to the splines on the shaft, and the external part is provided with helical flights or with segments for treating the material, the pitch and the configuration of which differ depending on the portion in question, for treating and transporting this material.

Thus, it is possible to use a large number of portions having configurations that differ according to the type of treatment to be carried out on the material.

The extruder 20 shown in FIGS. 2 and 3 include a zone A for continuously feeding the premoistened starchy raw material into the barrel 23 and for transporting this material toward the downstream of said extruder 20.

In this zone A, the barrel 23 is pierced, at its upstream end relative to the direction of flow of the material, by a port 26 surmounted by a hopper 16 into which the raw material delivered by the preconditioner 10 is continuously poured.

In the feeding zone A, the screws 21 and 22 are provided with long-pitch threads 28 so as to transport the raw material introduced via the orifice 26 which opens widely onto the two screws 21 and 22, so as to distribute said material into the flights of the screws.

In the embodiment shown in the figures, the barrel 23 includes, at the start of the feeding and transporting zone A, at least one water injection port 27 connected to a feed pump 3 in order to adjust the moisture content of the dough according to the moisture content of the dough to be obtained at the exit of the extruder 20, which must be between 20 and 27%. In this zone A, because of the mixing of the material by the flights 28, the temperature of the material progressively rises up to a temperature of around 130° C.

Thus, the material is transported toward the downstream of the extruder 20 into a zone B for mixing and cooking this material, which is heated to a temperature of between 90 and 150° C. in order to obtain a dough at the exit of this zone B.

Depending on the type of raw material, the cooking zone B comprises between two and five mixing screw segments.

In the embodiment shown in FIGS. 2 and 3, the mixing and cooking zone B is composed of three identical portions B1 placed one after another.

Each portion B1 comprises, on the one hand, a first part 30 provided with helical flights 30a that mesh with one another and, on the other hand, a second part 31 provided with diamond-shaped bilobate mixing segments, as shown in FIG. 5. The tops of these bilobate segments 31a are truncated in order to provide a controlled passage for the material, and these bilobate segments of each screw are offset by 90° with respect to one another. In addition, the bilobate segments 31a of the two screws 21 and 22 mesh with one another.

The length of each bilobate segment 31a is approximately equal to the diameter of one of the screws, 21 or 22.

Thus, the material leaving the first zone A undergoes, in the first part 30 of the first portion B1, compression by the flights 30a and then this material undergoes, in the second part 31 of said portion B1, controlled shearing by the bilobate segments 31a.

In this way, the material undergoes in the zone B a controlled succession of compression and shearing and, over the entire length of this zone B, its temperature is raised from 90 to 150° C., allowing a cooked dough to be obtained at the exit of this zone B.

To progressively raise the temperature of the material up to about 150° C., the barrel 23 of the extruder 20 is equipped with heating means.

As shown in FIGS. 2 and 3, the heating means are formed by a circuit 32 for circulating a heat-transfer fluid, or by resistance heating elements placed around the barrel and extending over the entire length of the zone B.

These heating means may also be formed by an induction heating system.

The length of the screws 21 and 22 in the mixing and cooking zone B is between 18 and 30 times the diameter of one of said screws. The residence time of the material in the cooking zone B is equal to or greater than 25 seconds and the moisture content of the dough leaving this zone is between 24 and 35%.

According to an alternative embodiment, and especially in the case of cereals, the zone B may include, after the last portion B1, at least one additional portion comprising a first part provided with conventional helical flights that mesh with one another and a second part formed from a shearing segment consisting of counterflights of known type.

On leaving this zone B, the dough is transferred into a venting zone C in which the screws 21 and 22 are provided with helical flights 34 and in which the barrel 23 is pierced by a port 35.

Upon being transferred into the zone C, the cooked dough undergoes venting, either natural venting or accelerated venting, and in the latter case the port 35 is connected to a vacuum pump 36, as shown in FIG. 1. This venting therefore allows water in vapor form contained in the dough to be extracted and results in cooling of this dough.

After this venting zone C, the extruder 20 has a zone D for pumping the dough and for cooling it to a temperature of about 90° C. at the exit of this extruder 20.

In this zone D, the screws 21 and 22 of the extruder are provided with helical flights 37 and the barrel 23 has cooling means that are formed, for example, by a circuit 38, provided within said barrel 23, for circulating a coolant.

The dough is thus pumped by the flights 37 of the screws 21 and 22 and transferred into a zone E for forming a continuous dough extrudate. To do this, the barrel 23 has an outlet 39 for the dough, the moisture content of which is between 20 and 30%.

The length of the screws 21 and 22 in the zones C and D is between 8 and 16 times the diameter of one of said screws.

The residence time of the material in the extruder is between 30 seconds and 1 min 30 s and the rotation speed of the screws is greater than 200 rpm and preferably greater than 250 rpm if this raw material consists of cereals.

At the end of the zone D, the barrel 23 may have a port (not shown) for injecting coloring agents and/or flavorings into the raw material.

As shown in FIGS. 1 and 6, the dough that leaves the extruder 20 at a temperature of around 90° C. is transferred in succession into the orienting chamber 40 and into the spreading chamber 50. The orienting chamber 40 may be provided with means for injecting coloring agents and/or flavorings into the dough. These chambers 40 and 50 are provided with means of known type (not shown) for regulating the temperature of the dough to between 80 and 100° C.

The orienting chamber 40 is formed by an elbowed pipe 41 for orienting the dough extrudate leaving the extruder 20 into a vertical direction, i.e. perpendicular to the axis of the extruder 20, so that it flows downward.

Preferably, the orienting chamber 40 is provided with means for regulating the distribution of the dough, which means are formed, in the embodiment shown in FIG. 6, by a first screen 42 placed at the inlet of this orienting chamber 40 and by a second screen 43 placed at the exit of said orienting chamber 40.

According to an alternative embodiment, means for regulating the distribution of the dough may be formed by a screen 42 placed at the inlet of this chamber 41 or by a screen 43 placed at the outlet of said chamber 41.

The screen or screens 42 and 43 are placed perpendicular to the direction of flow of the dough and make it possible to regulate the distribution of the dough, which is pushed out of the extruder 20; this dough, after it has passed into the orienting chamber 40, is transferred to the spreading chamber 50.

This spreading chamber 50 comprises a downwardy flared outer cone 51 and a male inner cone, leaving between them a space for spreading the dough. This chamber 50 also includes, above the mold 55, a filter 53 for retaining particles larger than 800 microns that are contained in the dough and a premolding screen 54 for adjusting the dough draw rates through the outlets of the mold 55.

Conventionally, this mold includes interchangeable inserts (not shown) that determine the shape of the product. Thus, the dough is spread out in the chamber 50 before passing in succession through the filter 53, the premolding screen 54 and the mold 55 in order to form a multitude of continuous strands having the desired shape.

On leaving the mold 55, the strands run into a box 61 that contains the means 60 for cutting these strands transversely in order to form the pellets.

These cutting means 60 are formed, for example, by at least one flexible and non-stick blade 62 that is rotated by a shaft 63 connected to a gearmotor (not shown). This blade 62 lies in a plane extending perpendicular to the direction in which the strands of dough leaving the mold 55 run.

The pellets thus cut drop onto a screen 64 and are discharged via an outlet pipe 65 by means of an air blowing system (not shown), the air being temperature- and flow-rate-regulated, and introduced into the box 61 via a pipe 66. The temperature-regulated air introduced into the box 61 via the pipe 66 passes through the screen 64 and drives the pellets out of said box 61 via the pipe 65, and these pellets are transferred to drying stations and then to stations for packaging them in hermetically sealed packages.

According to a preferred embodiment, the installation includes means 70 for discharging the dough output by the extruder 20, said means being placed before the spreading chamber 50.

As shown in FIG. 6, these discharge means 70 are formed by a branch pipe 71 that runs into the orienting chamber 40 and is provided with a flap 72 that can move between a position in which the branch pipe 71 is closed off, as shown in solid lines in FIG. 6, in order to direct the dough extrudate toward the spreading chamber 50, and a position in which the pipe 41 of said orienting chamber 40 is closed off, as shown in dotted lines in this figure, in order to direct the dough extrudate toward the discharge pipe 71.

Thus, until the water content of the dough output by the extruder 20 has reached a predetermined value, generally between 20 and 30%, that is to say upon starting up this extruder 20, the flap 72 is tilted by conventional-type drive means (not shown) in the position for closing off the pipe 41 of the spreading chamber 40, so as to direct the dough into the pipe 71 and consequently prevent this dough from passing through the spreading chamber 50 and contaminating the cutting assembly. As soon as the moisture content of the dough reaches the predetermined value, the flap 72 is returned to its initial position for closing off the discharge pipe 71, so as to direct this dough toward the spreading chamber 50.

Thanks to this device, the startup time of the installation is shorter, around 10-20 minutes, whereas in conventional installations it is about one hour. This time saving is also due to the fact that the installation comprises only a single extruder.

The rotation speed of the screws 21 and 22 of the extruder 20 is greater than 200 rpm depending on the raw material treated and the profile of these screws 21 and 22 is adapted in order to achieve progressive and controlled mixing, shearing and compression of the material in the extruder.

A wide variety of raw materials based on cereals and/or tubers may be used, by themselves or as a mixture.

The pellet-type food product obtained by the process according to the invention contains:

40 to 99% by weight of starch-containing material;

0 to 30% by weight of native or modified starch;

0 to 60% by weight of other, non-starchy ingredients; and

0 to 5% by weight of salt.

If the total percentage starch content in the formulation is less than or equal to 60%, the subsequent expansion of the end product is less and gives a firm and crunchy texture. Conversely, if the percentage starch content is greater than 60%, the expansion is greater and the texture more aerated and soft.

The installation also includes means 80 for drying the pellets., by progressively drying them from 50 to 110° C. at a relative humidity of between 40 and 80% for more than three hours in order to obtain the snacks having a uniform moisture content of between 10 and 12%.

Next, the pellets are expanded in order to obtain snacks with a cellular and crunchy texture having a moisture content of less than or equal to 3%.

The installation according to the invention therefore allows continuous production of pellets intended for the manufacture of snack-type food products with a cellular and crunchy texture from a natural starchy raw material, the various formulations of which are given in the table below.

| FORMULATION | TYPE OF INGREDIENT | % |
|---|---|---|
| 1 | Corn flour | 98 |
| | Salt | 2 |
| 2 | Wheat flour | 98 |
| | Salt | 2 |
| 3 | Potato starch | 88 |
| | Potato granules or flakes | 10 |
| | Salt | 2 |
| 4 | Corn flour | 93 |
| | Corn starch | 5.5 |
| | Salt | 1 |
| | Emulsifier | 0.5 |
| 5 | Corn starch | 50 |
| | Wheat starch | 25.5 |
| | Potato starch | 12 |
| | Manioc starch | 12 |
| | Emulsifier | 0.5 |

As an example, the parameters used in the installation according to the invention for formulation No. 1 were

amount of material entering the preconditioner: 200 kg/h

moisture content of the raw material in the preconditioner: 11.5%

rotation speed of the shafts of the preconditioner: 150 rpm

moisture content of the material leaving the preconditioner: 23%

temperature of the material leaving the preconditioner; 75° C.

screw speed of the extruder; 290 rpm

moisture content of the material in the feeding zone before the mixing and cooking zone: 29%

temperature of the material in the feeding zone before the mixing and cooking zone: 75° C.

temperature of the material in the mixing and cooking zone: 130° C.

temperature of the dough in the venting zone: 110° C.

temperature of the dough in the pumping and cooling zone: 95° C.

moisture content of the dough in the pumping and cooling zone: 27%

temperature of the cut and formed pellet leaving the mold: 90-95° C.

moisture content of the cut and formed pellet leaving the mold: 21%

rate of drawing of the cut and formed 85 pellet leaving the mold: cm/min

mean residence time of the material from entering the extruder until leaving the mold: 60-90 s

The pellets thus manufactured and then dried were semifinished products with a low water content of generally between 10 and 12% and with a high bulk density of around 200 to 700 g/l. They had a gelatinized and glassy appearance and were intended to be expanded at a later stage.

These products had a long shelf life because of their low moisture content.

1. A process for the continuous production of pellets that are intended for the manufacture of snack-type food products with a cellular and crunchy texture from a natural starchy raw material having a starch content equal to or greater than 60% and a protein content of less than 13%, characterized in that:
the material is preconditioned by adding water and/or steam in order to bring the moisture content of said raw material to between 15 and 40%;
the material is continuously introduced into a twin-screw extruder (20) having intermeshing co-rotating screws (21, 22) rotated at a speed of greater than 200 rpm about parallel axes inside a barrel (23), the residence time of the material in the extruder being between 30 seconds and 1 min 30 s;
the following steps are carried out in succession in the barrel (23) of the extruder (20):
a step of feeding and transporting the raw material,
a step of cooking this raw material at a temperature of between 90 and 150° C. and with a residence time of said material equal to or greater than 25 seconds, said cooking step comprising between two and five mixing steps in order to form a dough having a moisture content of between 24 and 35% and
a step of venting the dough and a step of pumping and cooling it to a temperature of between 80 and 100° C.;
a continuous dough extrudate having a moisture content of between 20 and 30% is formed at the exit of the extruder (20);
the dough extrudate is oriented into a vertical direction so as to flow downward through an orienting chamber (40) and at the same time the flow of the dough is regulated;
the dough is introduced into a spreading chamber (50) and, on leaving this chamber, the dough is pushed through a multi-outlet mold in order to form a multitude of continuous strands having the desired shape;
said strands are cut transversely in order to form the pellets with a moisture content of between 20 and 30%; and
the pellets are progressively dried at a temperature of between 50 and 110° C. and a relative humidity of between 40 and 80% for more than three hours in order to obtain pellets having a moisture content of between 10 and 12%.

2. The process as claimed in claim 1, characterized in that, after the pellets have been dried, they are expanded in the presence of hot air at a temperature of about 250° C. or in an oil bath at a temperature of around 180° C.

3. The process as claimed in claim 1 or 2, characterized in that the starchy raw material is based on cereals and/or tubers.

4. The process as claimed in any one of claims 1 to 3, characterized in that the starchy raw material has a particle size of between 50 and 800 microns.

5. The process as claimed in claim 1, characterized in that, at the start of the feeding and transporting step, water is injected into the extruder (20) in order to adjust the moisture content of the dough according to the moisture content of the dough to be obtained at the exit of the extruder (20).

6. The process as claimed in any one of claims 1 to 5, characterized in that, for a starchy raw material consisting of cereals, the cooking step includes at least one shearing step.

7. The process as claimed in any one of claims 1 to 6, characterized in that, for a starchy raw material consisting of cereals, the rotation speed of the screws (21, 22) is greater than 250 rpm.

8. The process as claimed in any one of claims 1 to 7, characterized in that flavorings and/or coloring agents are injected during the pumping and cooling step.

9. The process as claimed in any one of claims 1 to 8, characterized in that flavorings and/or coloring agents are injected into the orienting chamber (40).

10. The process as claimed in any one of the preceding claims, characterized in that, between the exit of the extruder (20) and the molding, the temperature of the dough is regulated to between 80 and 100° C.

11. The process as claimed in any one of the preceding claims, characterized in that, before the step of molding the dough, particles larger than 800 microns contained in this dough are retained and a premolding operation is carried out on said dough.

12. The process as claimed in any one of the preceding claims, characterized in that, during the startup phase of the extruder (20), the dough is directed to the exit of said extruder (20) into a discharge pipe (71) until the moment when the moisture content of this dough stabilizes at a value of between 20 and 30%.

13. An installation for the continuous production of pellets that are intended for the manufacture of snack-type food products with a cellular and crunchy texture from a natural starchy raw material having a starch content equal to or greater than 60% and a protein content of less than 13%, characterized in that it comprises:
a preconditioner (10) for mixing water and/or steam with the raw material in order to bring the moisture content of said raw material to between 15 and 40%;
an extruder (20) formed from two intermeshing co-rotating screws rotated at a speed of greater than 200 rpm about parallel axes inside an elongate barrel provided with intersecting bores, the length of the screws being between 32 and 48 times the diameter of said screws and said screws (21, 22) defining, from the upstream end to the downstream end:
a zone A for the continuous feeding into the barrel (23) of the preconditioned raw material and for transporting this raw material,
a zone B for cooking this raw material at a temperature of between 90 and 150° C. and with a residence time of said raw material equal to or greater than 25 seconds, the length of the screws (21, 22) in the cooking zone being between 18 and 29 times the diameter of one of said screws and this cooking zone comprising between two and seven mixing screw segments (31) in order to obtain a cooked dough having a moisture content of between 24 and 35%,
a zone C for venting the cooked dough and a zone D for pumping and cooling it to a temperature of between 80 and 100° C. and
a zone E for discharging the cooked dough from the extruder (20) in order to form a continuous dough extrudate having a moisture content of between 20 and 30%;
a chamber (40) for orienting the cooked dough extrudate into a vertical direction so as to flow downward and for regulating the fluid of the dough;
a chamber (50) for spreading the cooked dough, provided at its exit with a multi-outlet mold (55) in order to form a number of continuous strands having the desired shape;
means (60) for cutting said strands transversely in order to form the pellets; and
means for progressively drying the pellets at a temperature of between 50 and 110° C. and a relative humidity of between 40 and 80% for more than three hours in order to obtain the snacks having a content of between 10 and 12%.

14. The installation as claimed in claim 13, characterized in that the barrel (23) of the extruder (20) includes, at the start of the feeding and transporting zone A, at least one port (27) for injecting water in order to adjust the moisture content of the dough according to the moisture content of said dough to be obtained at the exit of this extruder (20).

15. The installation as claimed in claim 14, characterized in that each mixing screw segment (31) of the cooking zone B is formed by a diamond-shaped bilobate segment (31a), the tops of the lobes of which are truncated in order to provide a controlled passage for the material, the bilobate segments (31a) of each screw (21, 22) being offset by 90° with respect to one another and said bilobate segments (31a) of the two screws (21, 22) meshing with one another.

16. The installation as claimed in claim 15, characterized in that the length of each bilobate segment (31a) is approximately equal to the diameter of one of said screws (21, 22).

17. The installation as claimed in any one of claims 13 to 16, characterized in that the cooking zone B includes at least one shearing segment formed by counterflights in the case of a starchy raw material consisting of cereals.

18. The installation as claimed in any one of claims 13 to 17, characterized in that the length of the screws (21, 22) in the venting, pumping and cooling zones C and D is between 8 and 16 times the diameter of one of said screws.

19. The installation as claimed in any one of claims 13 to 18, characterized in that the barrel (23) of the extruder (20) includes, in the pumping and cooling zone D, at least one port for injecting coloring agents and/or flavorings.

20. The installation as claimed in any one of claims 13 to 18, characterized in that the orienting chamber (40) includes means for injecting coloring agents and/or flavorings into the dough.

21. The installation as claimed in claim 13, characterized in that the orienting chamber (40) and the spreading chamber (50) include means for regulating the temperature of the dough to between 80 and 100° C.

22. The installation as claimed in claim 13 or 21, characterized in that the orienting chamber (40) comprises an elbowed pipe (41) provided with means (42, 43) for regulating the distribution of the dough.

23. The installation as claimed in claim 22, characterized in that the means for regulating the distribution of the dough are formed by a screen (42) placed at the inlet of the orienting chamber (40) and/or a screen (43) placed at the exit of said chamber (40), said screen or screens extending perpendicularly to the direction of flow of the dough extrudate.

24. The installation as claimed in claims 13 to 21, characterized in that the spreading chamber (50) comprises a downwardly flared outer cone (51) and a male inner cone (52), leaving between them a space for spreading the dough.

25. The installation as claimed in claim 13 or 24, characterized in that the regulating chamber (50) includes, above the mold (55), a filter (53) for retaining particles larger than 800 microns that are contained in the dough and a premolding screen (54) for said dough.

26. The installation as claimed in claim 13, characterized in that the cutting means (60) are formed by at least one rotating blade (62) extending perpendicular to the direction of movement of the strands, said blade (62) being placed in a box (61) connected to an adjustable air blowing system for discharging the pellets from this box (61).

27. The installation as claimed in any one of claims 13 to 16, characterized in that it includes means (70) for discharging the dough output by the extruder (20) before the spreading chamber (50) until the moment when the moisture content of this dough reaches a value of between 20 and 30%.

28. The installation as claimed in claim 27, characterized in that the discharge means (70) are formed by a branch pipe (71) that runs into the orienting chamber (40) and is provided with a flap (72) that can move between a position in which the branch pipe (71) is closed off, in order to direct the dough extrudate toward the spreading chamber (50), and a position in which the pipe (41) of the orienting chamber (40) is closed off, in order to direct the dough extrudate toward said discharge pipe (71).

29. A food product in the form of expandable pellets that are intended for the manufacture of snacks, characterized in that it is obtained by the production process as claimed in any one of claims 1 to 12.

30. The food product as claimed in claim 29, characterized in that it is produced from a natural starchy raw material having a starch content equal to or greater than 60% and a protein content of less than 13%.

31. The food product as claimed in claim 30, characterized in that the starchy raw material is based on cereals and/or tubers.
